(19) United States
(12) Patent Application Publication
(10) Pub. No.: US 2015/0355914 A1
(43) Pub. Date: Dec. 10, 2015

(54) INFORMATION PROCESSING APPARATUS AND PROGRAM

(71) Applicant: Hitoshi YAMAMOTO, (US)

(72) Inventor: Hitoshi YAMAMOTO, Tokyo (JP)

(73) Assignee: Mitsubishi Electric Corporation, Chiyoda-ku, Tokyo (JP)

(21) Appl. No.: 14/652,348

(22) PCT Filed: Feb. 8, 2013
(86) PCT No.: PCT/JP13/00700

§ 371 Date: Jun. 15, 2015

(51) Int. Cl. G06F 9/44

(52) U.S. Cl. CPC G06F 9/4411

(57) ABSTRACT

A processor, a memory medium for storing an operating system (OS) to be executed by the processor, one or more devices which are re-initialized upon OS restart, an active OS, and a standby OS are provided. The active OS is executed at system startup to initialize the devices, and executes an OS process in a normal state after the system startup. The standby OS is executed at system startup to detect the devices connected to the processor, and initialize the detected devices, and goes to standby. When an abnormality occurs in the active OS and a restart is needed, the standby OS re-initializes the devices by using re-initialization data for the devices which had been stored during the initialization process before going to standby.

### TECHNICAL FIELD

The present invention relates to a startup time reduction technology upon OS (Operating System) restart in an information processing apparatus.

### BACKGROUND ART

Patent Document 1 discloses a system initialization information early setting method which is designed for an early start of a device operation at OS startup, by storing various kinds of system initialization data in a nonvolatile storage as fixed data in advance, and setting devices with reference to the nonvolatile storage at OS startup.

Patent Document 2 and Patent Document 3 disclose methods in which a plurality of pieces of boot information and startup programs are stored for active use and for standby use in a nonvolatile storage. When a system failure occurs during an operation under active boot information and an active startup program, the system is restarted by replacing standby boot information and a standby program to be used.

### CITATION LIST

### Patent Literature

Patent Document 1: JP 3-105618 A

Patent Document 2: JP 2004-78294 A

Patent Document 3: JP 2010-61419 A

### SUMMARY OF INVENTION

1. Technical Problem

The system initialization information early setting method disclosed in Patent Document 1 poses a problem of not being applicable to a system where the system configuration may be changed by addition or deletion of devices, for fear that stored system default data is inconsistent with installed devices.

The conventional OS restart methods for an information processing apparatus disclosed in Patent Documents 2 and 3 are designed to restart an OS by replacing active boot information and an active startup program by standby boot information and a standby startup program. This requires the initialization of devices installed in the system upon OS restart, which poses a problem of extra time required for OS restart.

The present invention is directed to solving problems as those discussed above. An objective is to achieve an information processing apparatus which is capable of restarting an OS with a reduced processing time for setting devices in a system where the system configuration may be changed.

2. Solution to Problem

An information processing apparatus according to this invention includes a processor; a memory medium, connected to the processor, that stores an operating system (OS) to be executed by the processor; one or more devices, connected to the processor, which are re-initialized upon OS restart; an active OS, executed by the processor at system startup, that performs an initialization process for the devices, and performs an OS process in a normal state after the system startup; and a standby OS, executed by the processor at the system startup, that detects the devices connected to the processor, performs an initialization process for the detected devices, and goes to standby; and when an abnormality occurs in the active OS, and a restart is needed, re-initializes the devices by using re-initialization data for the devices stored during the initialization process before going to the standby.

A program according to this invention causes a processor connected to one or more devices, which is provided in an information processing apparatus, to execute: a process, at system startup, to load a standby OS (Operating System) and an active OS from a nonvolatile storage medium to a memory medium for storing an OS to be executed by the processor; an initialization process, after the standby OS and the active OS have been loaded, to detect the devices connected to the information processing apparatus by using the standby OS, and initialize the devices; a storing process to store, in the memory medium, initialization data for the devices generated during the initialization process, as re-initialization data; a process, after the storing process, to put the standby OS on standby and execute the active OS; and when the standby OS is restarted, a process to re-initialize the devices by using the re-initialization data stored by the storing process before the standby.

3. Advantageous Effects of Invention

According to the present invention, a standby OS which controls devices connected to a system in a normal state after OS restart initializes the devices during system startup and stores re-initialization data for the devices. Upon OS restart, the standby OS re-initializes the devices with reference to the stored re-initialization data for the devices. This can contribute to a reduction in processing time required for initializing the devices upon OS restart even in an information processing apparatus where the system configuration may be changed due to a change in the devices to be connected.

### BRIEF DESCRIPTION OF DRAWINGS

FIG. 1 is a configuration diagram illustrating a configuration of an information processing apparatus according to a first embodiment of the present invention.

FIG. 2 is a configuration diagram illustrating configurations of a ROM and a RAM of the information processing apparatus according to the first embodiment of the present invention.

FIG. 3 is a configuration diagram illustrating a configuration of a boot loader of the information processing apparatus according to the first embodiment of the present invention.

FIG. 4 illustrates a whole configuration diagram of an active OS and a standby OS of the information processing apparatus according to the first embodiment of the present invention.

FIG. 5 illustrates examples of processing flows of device initialization and device re-initialization according to the first embodiment of the present invention.

FIG. 6 shows flow charts illustrating a startup operation of the information processing apparatus according to the first embodiment of the present invention.

FIG. 7 shows flow charts illustrating an OS restart operation of the information processing apparatus according to the first embodiment of the present invention.

FIG. 8 is a configuration diagram illustrating configurations of a ROM and a RAM of an information processing apparatus according to a second embodiment of the present invention.

FIG. 9 is a diagram illustrating a configuration of a boot loader of the information processing apparatus according to the second embodiment of the present invention.

FIG. 10 is a diagram illustrating a configuration of a common OS of the information processing apparatus according to the second embodiment of the present invention.

FIG. 11 shows a flow chart illustrating a startup operation of the information processing apparatus according to the second embodiment of the present invention.

FIG. 12 shows a flow chart illustrating a startup process of the common OS of the information processing apparatus according to the second embodiment of the present invention.

FIG. 13 is a configuration diagram illustrating configurations of a ROM and a RAM of an information processing apparatus according to a third embodiment of the present invention.

FIG. 14 illustrates a whole configuration diagram of an active OS and a standby OS of the information processing apparatus according to the third embodiment of the present invention.

FIG. 15 shows flow charts illustrating a startup operation of the information processing apparatus according to the third embodiment of the present invention.

FIG. 16 shows flow charts illustrating an OS restart operation of the information processing apparatus according to the third embodiment of the present invention.

### DESCRIPTION OF EMBODIMENTS

Embodiments of the present invention are described hereinafter with reference to the drawings. In the following description of the embodiments, portions that are the same as each other or correspond to each other are assigned the same reference signs. Boot loaders and OSs described hereinafter are programs to be executed by a processor. In the descriptions of the configurations of the boot loaders and the OSs, a portion having a name ending with a “section” is a program functional block.

### Embodiment 1

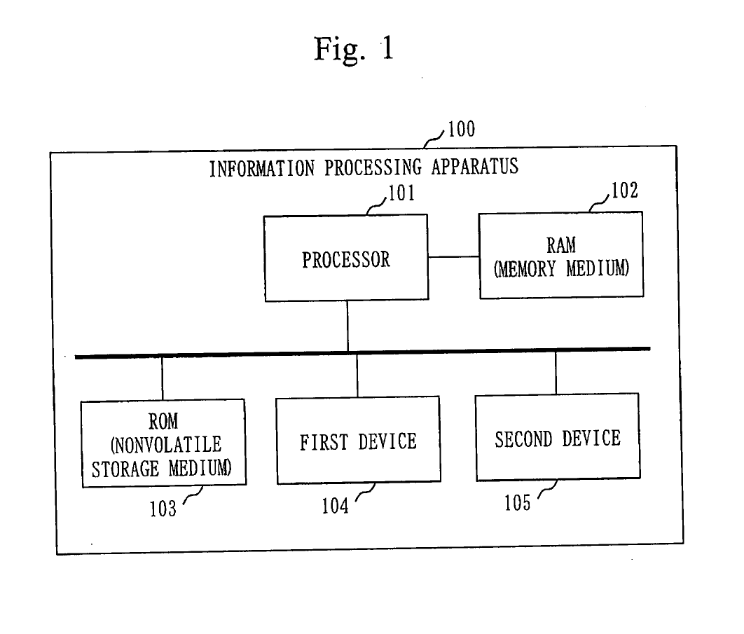

FIG. 1 is a configurational diagram illustrating a system configuration of an information processing apparatus according to a first embodiment of the present invention. Referring to FIG. 1, a processor 101 is connected to a RAM (Random Access Memory) 102 which is a memory medium for storing OSs. Additionally, a ROM (Read Only Memory) 103 which is a nonvolatile storage medium for storing OS images, a first device 104 and a second device 105 are also included. DRAM (Dynamic RAM) is an example of the RAM 102. Flash ROM is an example of the ROM 103. Examples of the first device 104 and the second device 105 include Serial Communication Interface (hereinafter, referred to as SCI) which provides the processor with an external communication interface, and Compare Match Timer (hereinafter, referred to as CMT) which compares a timer value with a set value, and when the values match, notifies the processor. Referring to the system configuration, there are two devices connected herein as an example. However, the number of devices is not limited to two according to the present invention. Alternatively a plurality of devices of the same kind may be connected. Further, the direct connection of these storage media and devices to the processor is not the only possibility. Alternatively, the connection may be done via a circuit such as a bridge.

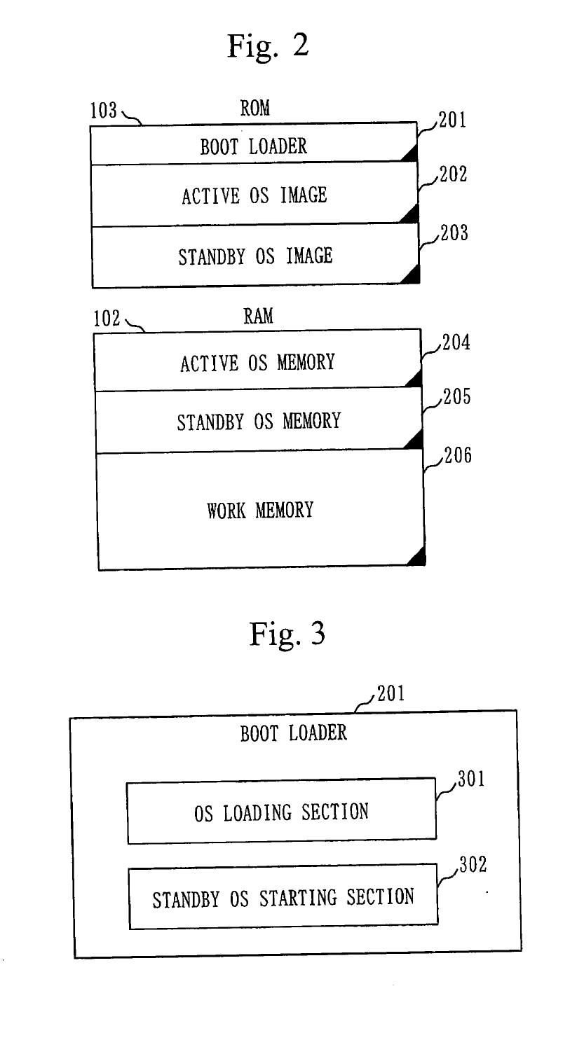

FIG. 2 is a configuration diagram illustrating information stored in the ROM 103 and a location of each item of the information, and an arrangement according to usage of the memory areas of the RAM 102, in the information processing apparatus 100. The zoning of the ROM 103 and the RAM 102 herein is shown as an example, which does not limit the arrangement according to the present invention. Alternatively, information and an area not described herein may be included. Referring to the zoning of the RAM 102, the area may be divided into fixed areas in advance, or the areas may be decided according to the required size at startup of the information processing apparatus 100.

Information to be stored in the ROM 103 includes a boot loader 201, an active OS image 202 and a standby OS image 203. The boot loader 201 is a program executed first by the processor 101 at system startup of the information processing apparatus 100 to load OSs from the ROM 103 to the RAM 102 so that the processor 101 starts executing the loaded OSs. The active OS image 202 is an image (program data) of an OS to be executed by the processor 101 in a normal state after system startup. The standby OS image 203 is an image of an OS to be executed by the processor 101 in a normal state after OS restart.

The memory area of the RAM 102 is divided according to usage into an active OS memory 204 to which the active OS image 202 is loaded, a standby OS memory 205 to which the standby OS image 203 is loaded, and a work memory 206 which is a working memory for an OS in execution by the processor 101.

FIG. 3 is a diagram illustrating a configuration of the boot loader 201. The boot loader 201 includes an OS loading section 301 which loads OSs to the active OS memory 204 and the standby OS memory 205 in the RAM 102, and a standby OS starting section 302 which causes the processor 101 to start executing the loaded OS in the standby OS memory 205.

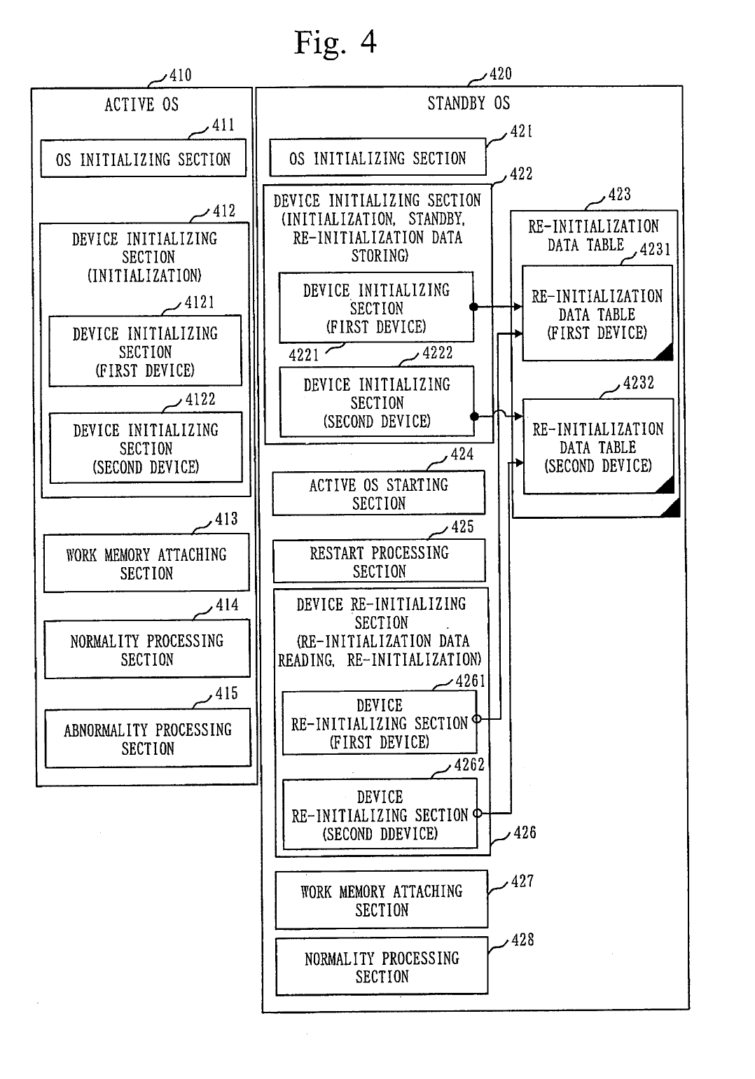

FIG. 4 illustrates a whole configuration diagram of an active OS 410 and a standby OS 420 of the information processing apparatus 100 according to the first embodiment. The active OS 410 is the OS of the active OS image 202 loaded to the active OS memory 204 by the OS loading section 301 of the boot loader 201 executed by the processor 101. The standby OS 420 is the OS of the standby OS image 203 loaded to the standby OS memory 205 by the processor 101.

The active OS 410 includes an OS initializing section 411 executed by the processor 101 initializing the active OS 410; a device initializing section 412 executed by the processor 101 when devices installed in the information processing apparatus 100 are initialized; a work memory attaching section 413 executed when the work memory 206 is added to the control of the active OS 410; a normality processing section 414 executed when an OS process such as device control and process scheduling is performed, in a normal state after the system startup process has been completed; and an abnormality processing section 415 executed when an abnormality such as a memory access at an illegal address, for example, occurs during the execution of the active OS 410.

The device initializing section 412 is provided with an initialization function for each of the implemented devices. The device initializing section 412 may add or delete an initialization module for each device to/from the OS, in response to addition or deletion of a device to/from the information processing apparatus 100 so as to provide an appropriate device initialization function. Alternatively, the device initializing section 412 may have an initialization function for a device connectable to the information processing apparatus 100, in advance. The information processing apparatus 100 of this embodiment is provided with a device initializing section 4121 and a device initializing section 4122 for initializing the first device 104 and the second device 105, respectively.

An initialization process performed by the device initialing section 412 includes a specification of communication protocol such as an asynchronous type or a clock synchronization type, and a specification of a communication rate, when the device is an SCI, for example. When the device is a CMT, the initialization process includes parameter setting to the CMT so as to generate interrupts to the processor 101 at fixed intervals, for example.

The standby OS 420 includes an OS initializing section 421 executed by the processor 101 to initialize the standby OS 420; a device initializing section 422 executed when devices installed in the information processing apparatus 100 are initialized, the standby OS is put on standby, and device re-initialization data required for device re-initialization is stored in a re-initialization data table 423; an active OS starting section 424 executed when the processor 101 causes the active OS 410 to start processing; a restart processing section 425 executed when the standby OS 420 is restarted; a device re-initializing section 426 executed when the devices are re-initialized with reference to the re-initialization data table 423; a work memory attaching section 427 executed when the work memory 206 is added to the control of the standby OS 420; and a normality processing section 428 executed when the OS process in the normal state is performed in the same manner as that of the active OS 410, in the normal state after OS restart.

The device initializing section 422 of the standby OS 420, like the device initializing section 421 of the active OS 410, is provided with device initializing sections 4221 and 4222 as initialization functions for the respective implemented devices. The re-initialization data table 423 stores device re-initialization data for each of the implemented devices. This embodiment employs a re-initialization data table 4231 for the first device 104 and a re-initialization data table 4232 for the second device 105. This area for each device may be assigned in advance, or dynamically assigned during device initialization.

The device re-initializing section 426 of the standby OS 420, like the device initializing section 412 of the active OS 410, is provided with a re-initialization function for each of the implemented devices. According to the information processing apparatus 100 of this embodiment, a device re-initializing section 4261 for re-initializing the first device 104 and a device re-initializing section 4262 for re-initializing the second device 105 are provided. The device re-initializing section 4261 refers to the re-initialization data table 4231, and the device re-initializing section 4262 refers to the re-initialization data table 4232,

The device re-initialization data is the data that is set to a device during the device initialization. For example, when the device is an SCI, the device re-initialization data is a set value, such as a protocol or a communication rate, to operate the SCI appropriately. When the device is a CMT, the device re-initialization data is a set value, such as a timer value, to cause the CMT to generate interrupts at appropriate intervals, for example.

After the system startup, when the processor 101 have executed the active OS 410, and the information processing apparatus 100 is in operation, an application program is executed and use the first device 104 and the second device 105. For this reason, these devices may have a change in the settings appropriately to the executed application program. As a result, the state of a device upon OS restart is different from the state of the device after the device initialization, which requires device re-initialization.

For example, when the device is an SCI, and the transfer rate of the SCI at OS startup is 9600 bits per second by default, when the application program used the SCI at a transfer rate of 115200 bits per second, the set transfer rate of the SCI has been changed to 115200 bits per second. Thus, upon OS restart, the transfer rate needs to be reset to the default of 9600 bits per second.

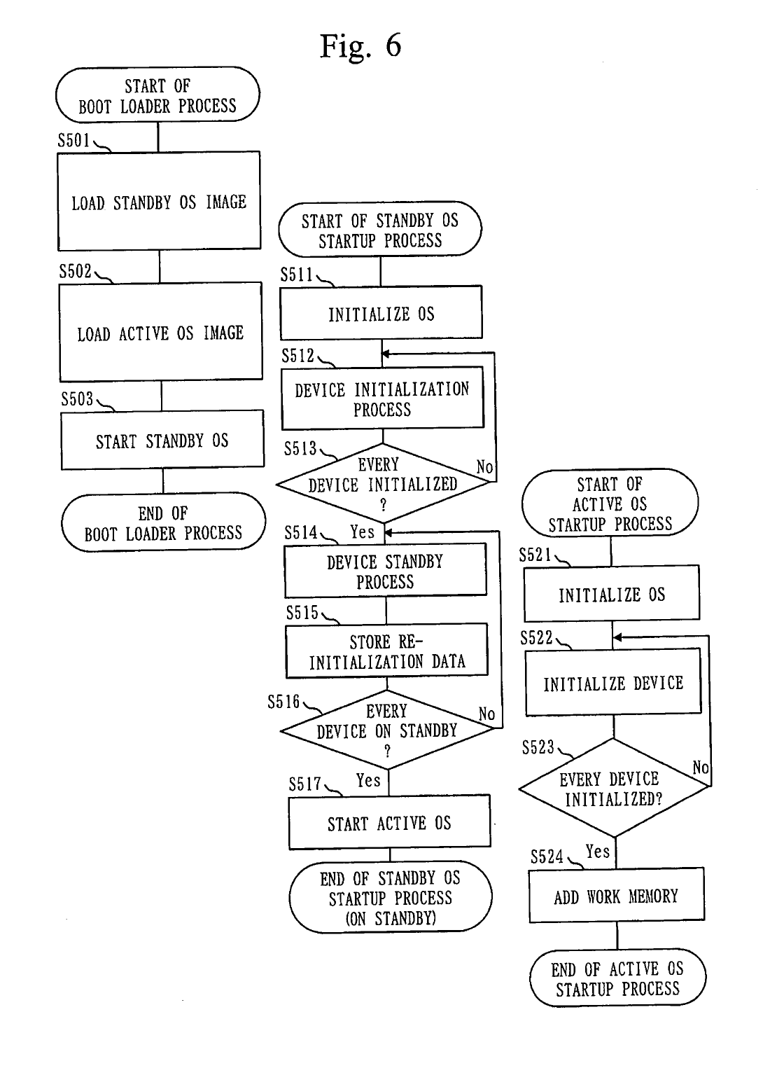

An operation of the information processing apparatus 100 according to the first embodiment of the present invention is described. FIG. 6 shows flow charts illustrating an operation of the information processing apparatus 100 at system startup. When the information processing apparatus 100 is started, the processor 101 starts executing the boot loader 201, first. The processing by the boot loader 201 is as follow. First, the OS loading section 301 is executed to load the standby OS image 203 to the standby OS memory 205 (S501), and load the active OS image 202 from the ROM 103 to the active OS memory 204 in the RAM 102 (S502). Herein, the standby OS image 203 and the active OS image 202 are loaded in that order, which does not limit the loading order according to the present invention. Alternatively, a parallel loading may be employed.

Then, after the active OS image 202 and the standby OS image 203 have been loaded, the standby OS starting section 302 is executed (S503) and the processor 101 starts executing the standby OS 420. Here, the processing by the boot loader 201 ends.

After having started executing the standby OS 420, the processor 101 causes the OS initializing section 421 to initialize the standby OS 420 (S511), first. The processor 101 then causes the device initializing section 422 to perform device initialization process of the standby OS (S512).

The device initialization at S512 is performed for each of the devices connected to the information processing apparatus 100. When S512 has been performed for one device, it is checked whether the initialization has been completed for every device (S513). If uncompleted, a next device is selected, and the process returns to S512. If completed, the process proceeds to the next step. According to the information processing apparatus 100 of this embodiment, since the first device 104 and the second device 105 are implemented, the processor 101 causes the device initializing section 4221 and the device initializing section 4222 in that order to initialize the respective devices.

There are various possible methods of checking at S513 including one based on device configuration information obtained by searching and detecting a device connected to the information processing apparatus 100, and another by detecting a connected device based on system configuration information stored at a change in the system configuration of the information processing apparatus 100.

Upon completing the initialization process of S512 for every device, the processor causes the device initializing section 422 to perform a device standby process to put the devices on standby (S514) and store the device re-initialization data in the re-initialization data table 423 (S515). The device re-initialization data to be stored herein includes data that has been set to the devices during device initialization of S512.

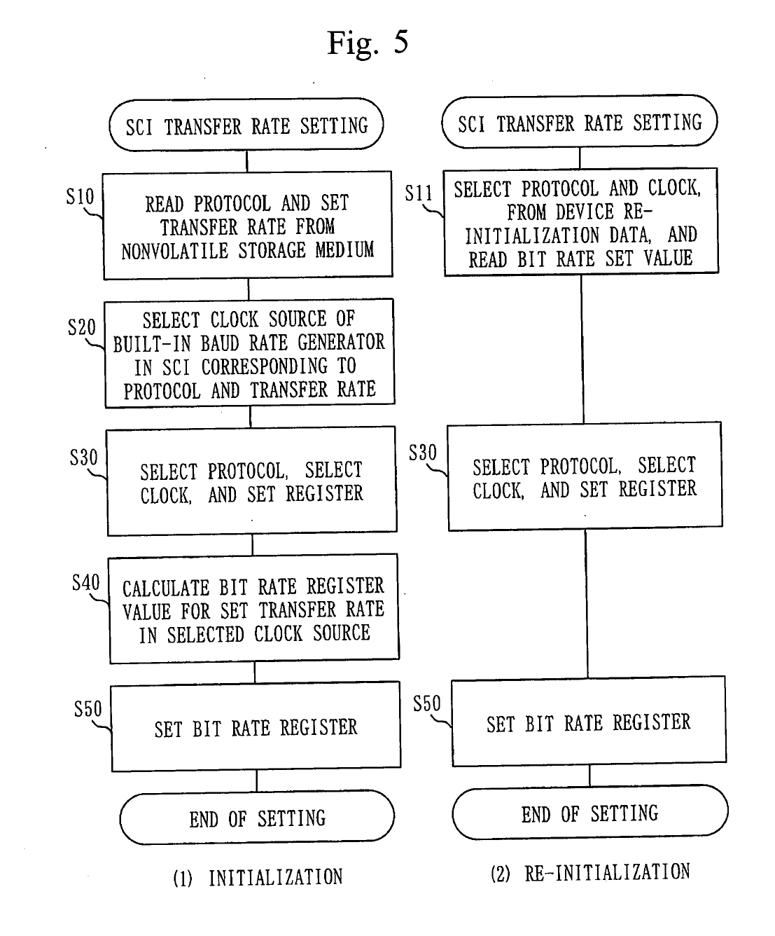

For example, when the device is an SCI and provided with a clock source selection register and a bit rate setting register, these registers are usually set during initialization through a procedure shown in FIG. 5(1). First, a protocol and a set transfer rate are obtained from the nonvolatile storage medium (S10). Then, a clock source selection corresponding to the obtained settings is performed (S20). Then, the protocol and the selected clock are set to the registers of the SCI (S30). Then, a set value of a bit rate register value for the set transfer rate in the selected clock source is calculated (S40). Then, the determined bit rate register set value is set to the registers of the SCI (S50).

On the other hand, when the register set values upon initialization is stored as the re-initialization data, and this information is used for re-initialization, the registers can be set through a procedure shown in FIG. 5(2) including: reading the selected protocol, the selected clock, and the bit rate set value from the device re-initialization data (S11), and processing S30 and S50. Thus, the processing of S20 and S40 can be omitted.

Thus, in the startup process of the standby OS 420 at system startup, connected devices are detected, initialization is performed for currently connected devices, and set data during this initialization is stored as the re-initialization data. This allows the device re-initialization, upon OS restart to operate the standby OS 420 again, to be performed through the simpler process than the process using the re-initialization data upon the device initialization, for the currently connected devices which have been detected at system startup.

Like the device initialization process at S512, after having performed the device standby process of S514 and the re-initialization data storing of S515 for one device, the processor checks whether S514 and S515 have been completed for every device (S516). If uncompleted, a next device is selected and the process returns to S514. If completed, the process proceeds to the next step. According to the information processing apparatus 100 of this embodiment, S514 and S515 are executed for the first device 104 and for the second device 105.

Herein, it has been described that the device standby process of S514 and the re-initialization data storing of S515 are performed after the device initialization process of S512 has been completed for every device. Alternatively, a set of processing of S512 to 5515 may be performed on a device by device basis, or performed in parallel, instead of doing in a sequential order on a device by device basis.

Upon completing the processing of S514 and S515 for every device, the processor 101 causes the active OS starting section 424 to start executing the active OS 410 (S517). Here, the startup process of the standby OS 420 is completed, and the standby OS 420 goes to standby.

Upon executing the active OS 410, the processor 101 causes the active OS initializing section 411 to initialize the active OS 410 (S521), first. Then, the processor 101 causes the device initializing section 412 of the active OS 410 to initialize the devices (S522). The device initialization at S522 is performed sequentially for each of the devices implemented in the information processing apparatus 100. When S522 has been performed for one device, it is checked whether the initialization has been completed for every device (S523). If uncompleted, a next device is selected and the process returns to S522. If completed, the process proceeds to the next step.

According to the information processing apparatus 100 of this embodiment, the device initializing section 4121 and the device initializing section 4122 are executed in that order to initialize the first device 104 and the second device 105, respectively. Although it has been described herein that S522 is performed for the first device 104 and then for the second device 105, S522 may be performed in a different order, or in parallel, instead.

Upon completing the device initialization of S522 for every device, the processor 101 causes the work memory attaching section 413 to add the work memory 206 to the control of the active OS 410 (S524). The startup process of the active OS 410 is completed here. The processor 101 then causes the normality processing section 414 of the active OS 410 to perform the OS process in the normal state after the completion of the startup process.

According to the present invention, however, the operation procedure at system startup is not limited to the procedure described above. Alternatively, the system may be started by using a different procedure as long as the operation result is equivalent.

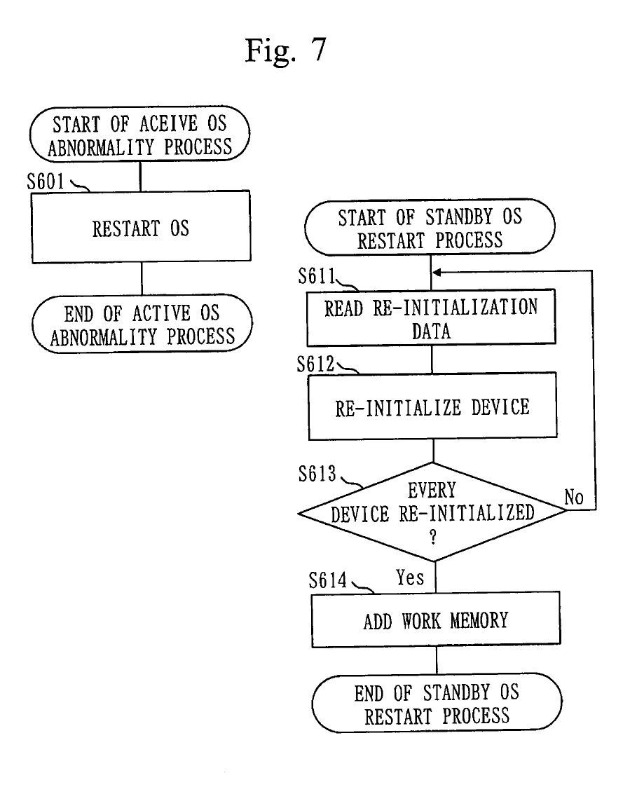

Next, an OS restart operation is described. FIG. 7 shows flow charts illustrating an OS restart operation when the processor 101 detects an abnormality while executing the active OS 410, in the information processing apparatus 100 of the first embodiment. When detecting an abnormality during the execution of the active OS 410, the processor 101 executes the abnormality processing section 415 of the active OS. The processor 101 causes the restart processing section 425 of the standby OS 420 to start a standby OS restart process (S601).

Upon starting the restart process of the standby OS 420, the processor 101 causes the device re-initializing section 426 to refer to the re-initialization data table 423 (S611), obtain parameters to be set to the devices, set the obtained parameters to the devices to be re-initialized (S612), first. The device re-initializing section 426 re-initializes the currently connected devices sequentially on a device by device basis, and checks whether the re-initialization of S612 has been completed for every device (S613). If uncompleted, a next device is re-initialized (S611, S612). If completed, the process proceeds to the next step.

According to this embodiment, the device re-initializing section 4261 and the device re-initializing section 4262 re-initialize the first device 104 and the second device 105 in that order with reference to the re-initialization data table 4231 and the re-initialization data table 4232, respectively. Although it has been described herein that the first device 104 and the second device 105 are re-initialized in that order, the devices may be re-initialized in a different order, or in parallel, instead.

When it is determined at S613 that re-initialization has been completed for every device, the processor 101 causes the work memory attaching section 427 to add the work memory 206 to the control of the standby OS 420 (S614). The restart process of the standby OS 420 is completed here. This is the end of the OS restart operation of the information processing apparatus 100. Then, the processor 101 causes the normality processing section 428 of the standby OS 420 to perform the OS process in the normal state after OS restart.

As aforementioned, the standby OS stores the device re-initialization data according to the startup system configuration, at each system startup of the information processing apparatus, and upon OS restart, re-initializes currently connected devices with reference to the stored re-initialization data. This can contribute to a reduction in processing time required for setting devices upon OS restart, even in an information processing apparatus where a system configuration change may occur due to a change in the devices to be connected.

Further, at system startup of the information processing apparatus, the standby OS is loaded from the nonvolatile storage medium storing the OS image to the memory medium storing the OS, and initialized. Therefore, the loading and initialization of the standby OS can be eliminated upon OS restart. This can contribute to a reduction in OS startup time upon OS restart.

Further, the active OS and the standby OS share a work memory. This can contribute to saving the work memory required for the system.

### Embodiment 2

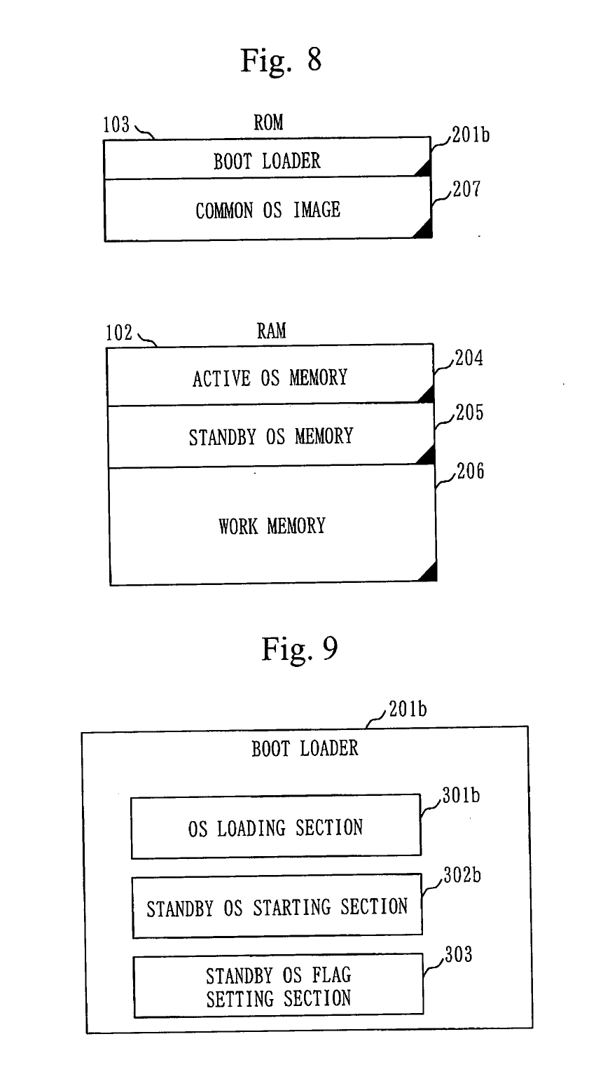

A second embodiment of the present invention is described. The information processing apparatus of the second embodiment is similar in configuration to the information processing apparatus of the first embodiment illustrated in FIG. 1. FIG. 8 shows a configuration diagram illustrating information stored in the ROM 103 and a location of each item of the information, and an arrangement according to usage of memory areas of the RAM 102, in the information processing apparatus 100 according to the second embodiment. The RAM 102 is the same as that described in the first embodiment, and will not be discussed in detail.

Information stored in the ROM 103 includes a boot loader 201b and a common OS image 207 which is common to both an OS executed in the normal state after system startup and an OS executed in a normal state after OS restart. The area assignment of the ROM 103 shown herein is only an example which does not limit the arrangement according to the present invention. Alternatively, the ROM 103 may store information not described herein.

FIG. 9 illustrates a configuration of the boot loader 201b. The boot loader 201b includes an OS loading section 301b for loading the common OS image 207 to the standby OS memory 205 and the active OS memory 204, of the RAM 102; a standby OS starting section 302b for causing the processor 101 to start executing the OS loaded to the standby OS memory 205; and a standby OS flag setting section 303 for setting a standby OS flag 432, described below, to the OS loaded to the RAM 102.

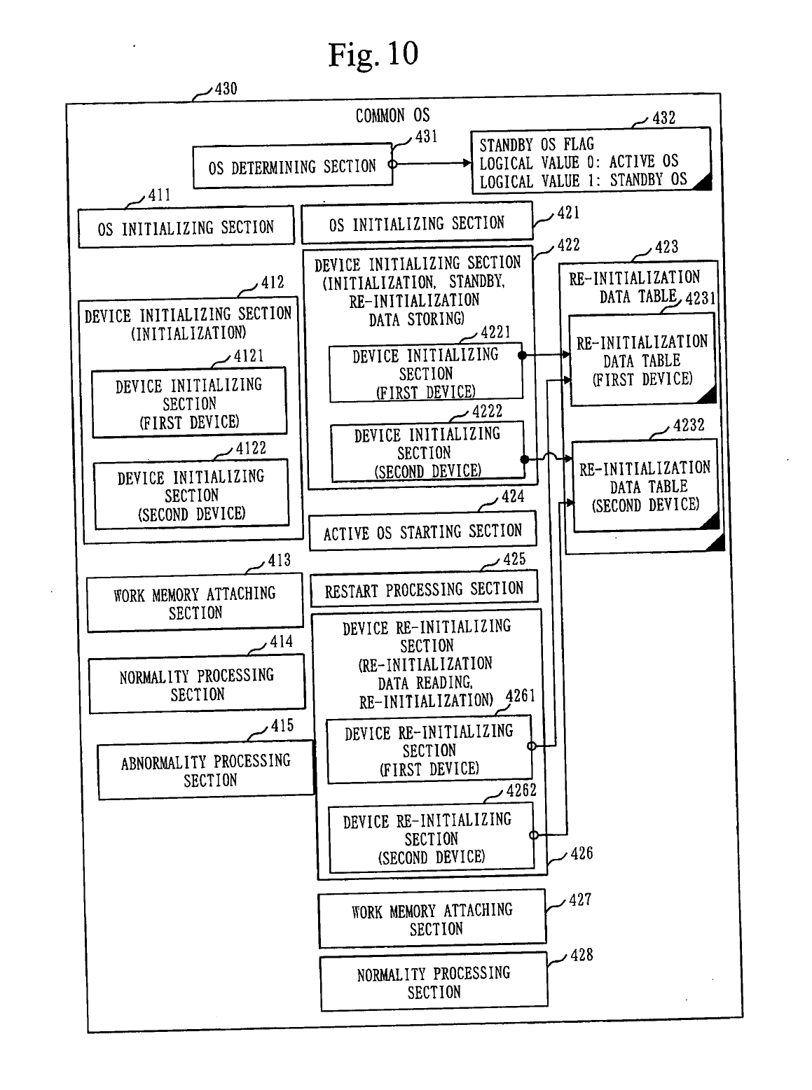

FIG. 10 illustrates a configuration of a common OS 430 of the common OS image 207 loaded to the RAM 102 of the information processing apparatus 100 of the second embodiment. Referring to FIG. 10, portions assigned the same reference signs as those of FIG. 4 are similar to those described in the first embodiment, and will not be discussed herein. The common OS 430 includes an OS determining section 431 and the standby OS flag 432. In this embodiment, the common OS 430 is configured to include the same functions as those of the active OS and the standby OS illustrated in FIG. 4. Alternatively, the common OS 430 may be configured to have a common function to the functions of the active OS and the standby OS.

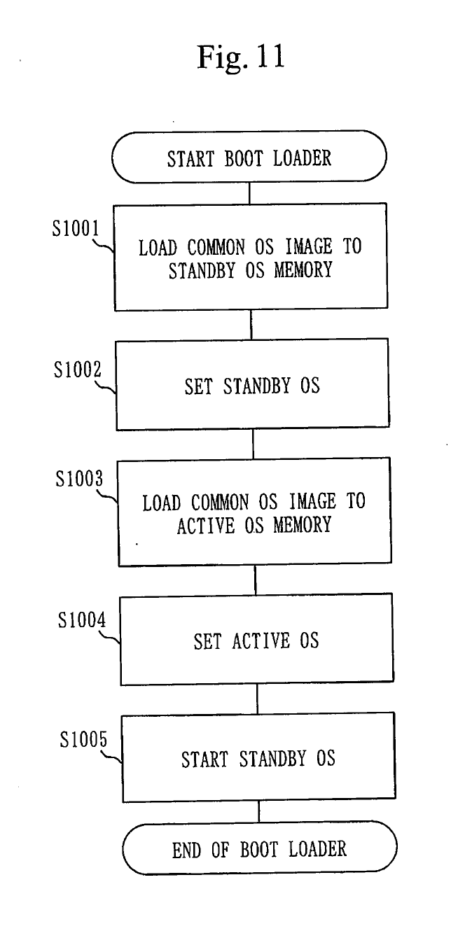

An operation of the information processing apparatus 100 according to the second embodiment of the present invention is described. FIG. 11 is a flow chart illustrating an operation at system startup of the information processing apparatus 100 of the second embodiment. When the information processing apparatus 100 is started, the processor 101 executes the boot loader 201b, first. Processing by the boot loader 201b is as follows. First, the OS loading section 301b is executed to load the common OS image 207 from the ROM 103 to the standby OS memory 205 (S1001). Then, the standby OS flag setting section 303 is executed to set the standby OS flag 432 of the common OS 430 loaded to the standby OS memory 205 to a logical value 1 indicating the type of OS: the standby OS (S1002). Then, the OS loading section 301b is executed again to load the common OS image 207 to the active OS memory 204 (S1003). Then, the standby OS flag setting section 303 is executed to set the standby OS flag 432 of the common OS 430 loaded to the active OS memory 204 to a logical value 0 indicating the type of OS: the active OS (S1004). Herein, the standby OS memory 205 and the active OS memory 204 are loaded in that order, which however does not limit the loading order according to the present invention. Alternatively, a parallel loading is also possible. Finally, the standby OS starting section 302b is executed, and the processor 101 starts executing the common OS 430 in the standby OS memory 205 (S1005). Here, the processing by the boot loader 201b is completed.

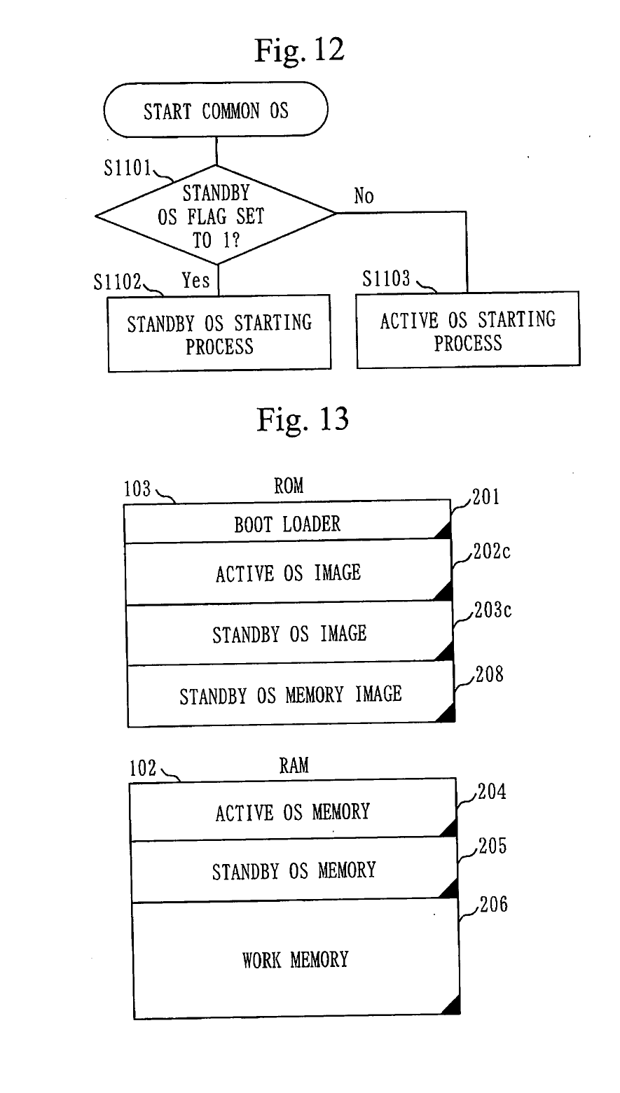

FIG. 12 is a flow chart illustrating an operation when the processor 101 starts executing the common OS 430. Upon executing the common OS 430, the processor 101 causes the OS determining section 431 to refer to the standby OS flag 423 to determine whether the common OS 430 in execution is the standby OS or the active OS (S1101), first. When the execution of the common OS 430 loaded to the standby OS memory 205 is started, since the standby OS flag 432 has been set to the logical value 1 by the standby OS flag setting section 303, it is determined that the common OS 430 is the standby OS, in the OS determination process at S1101. Then, the common OS 430 is executed as the standby OS, and the same process as the standby OS startup process illustrated in FIG. 6 is started (S1102). When the active OS starting section 424 is executed after the startup process as the standby OS has been performed, the processor 101 starts executing the common OS 430 loaded to the active OS memory 204. Since it is determined at S1101 that the common OS 430 in the active OS memory 204 is the active OS, the common OS 430 is executed as the active OS, and then the same process as the active OS startup process illustrated in FIG. 6 is performed (S1103). The rest of the operation is the same as that described in the first embodiment.

As aforementioned, the common OS is provided with the OS determining section and the standby OS flag, to determine whether the common OS is the standby OS or the active OS with reference to the standby OS flag at startup of the common OS, and the boot loader is provided with the standby OS flag setting section to set the standby OS flag. This allows the standby OS and the active OS to share the same OS image.

Further, the standby OS stores the device re-initialization data according to the startup system configuration at each system startup of the information processing apparatus, and upon OS restart, the standby OS re-initializes currently connected devices with reference to the stored device re-initialization data. This can contribute to a reduction in processing time required for setting devices upon OS restart even if there is a system configuration change in the information processing apparatus due to a change in the connected devices.

Further, at system startup of the information processing apparatus, the standby OS is loaded from the nonvolatile storage medium storing the OS image to the memory medium storing the OS, and initialized. Therefore, there is no need for loading and initializing the standby OS upon OS restart. This can contribute to a reduction in the startup time of the standby OS upon OS restart.

Further, the active OS and the standby OS share a work memory. This can contribute to saving the work memory required for the system.

### Embodiment 3

A third embodiment of the present invention is described. The information processing apparatus according to the third embodiment is similar in configuration to the information processing apparatus of the first embodiment illustrated in FIG. 1. FIG. 13 shows a configuration diagram illustrating information stored in the ROM 103 of the information processing apparatus 100 of the third embodiment and a location of each item of the information, and the arrangement of the memory area of the RAM 102 according to usage. The RAM 102 is the same as that of the first embodiment, and therefore will not be discussed here in detail.

Information stored in the ROM 103 of the information processing apparatus 100 of the third embodiment includes the boot loader 201 which is the same as that described in the first embodiment, an active OS image 202c, a standby OS image 203c and a standby OS memory image 208. The standby OS memory image 208 is a memory image of information which had been stored in the standby OS memory 205 of the RAM 102 at the time when the standby OS startup process was completed at system startup. However, the area assignment of the ROM 103 herein is only an example which does not limit the arrangement according to the present invention. Alternatively, information not described herein may be stored in the ROM 103.

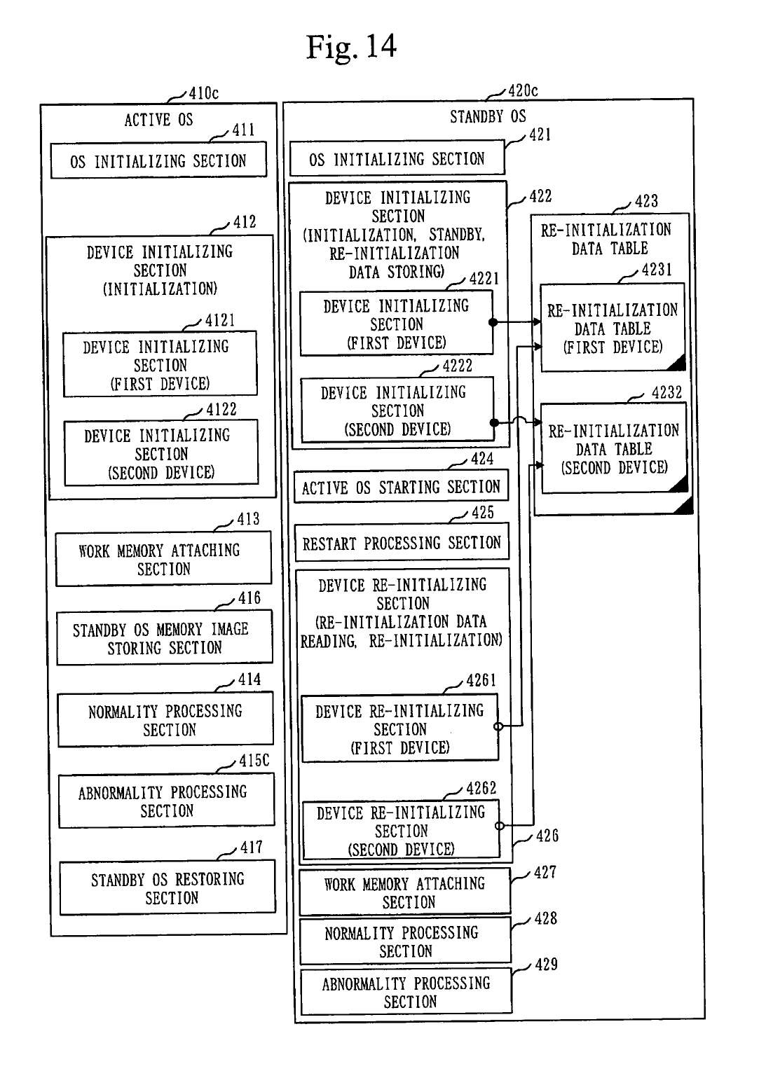

FIG. 14 illustrates a configuration of an active OS 410c and a configuration of a standby OS 420c, of the information processing apparatus 100 according to the third embodiment.

The active OS 410c includes the OS initializing section 411, the device initializing section 412, the work memory attaching section 413 and the normality processing section 414, which are similar to those described in the first embodiment. The active OS 410c also includes a standby OS memory image storing section 416 for storing in the ROM 103 the information of the standby OS memory 205 as the standby OS memory image 208; an abnormality processing section 415c for performing an abnormality process when an abnormality occurs during the execution of the active OS 410c; and a standby OS restoring section 417 for reading the standby OS memory image 208 from the ROM 103, and restoring the standby OS 420c in the standby OS memory 205 in the RAM 102.

The standby OS 420c includes an abnormality processing section 429 executed when an abnormality occurs during the execution of the standby OS 420c, in addition to the standby OS initializing section 421, the device initializing section 422, the re-initialization data table 423, the active OS starting section 424, the restart processing section 425, the device re-initializing section 426, the work memory attaching section 427 and the normality processing section 428, which are similar to those described in the first embodiment.

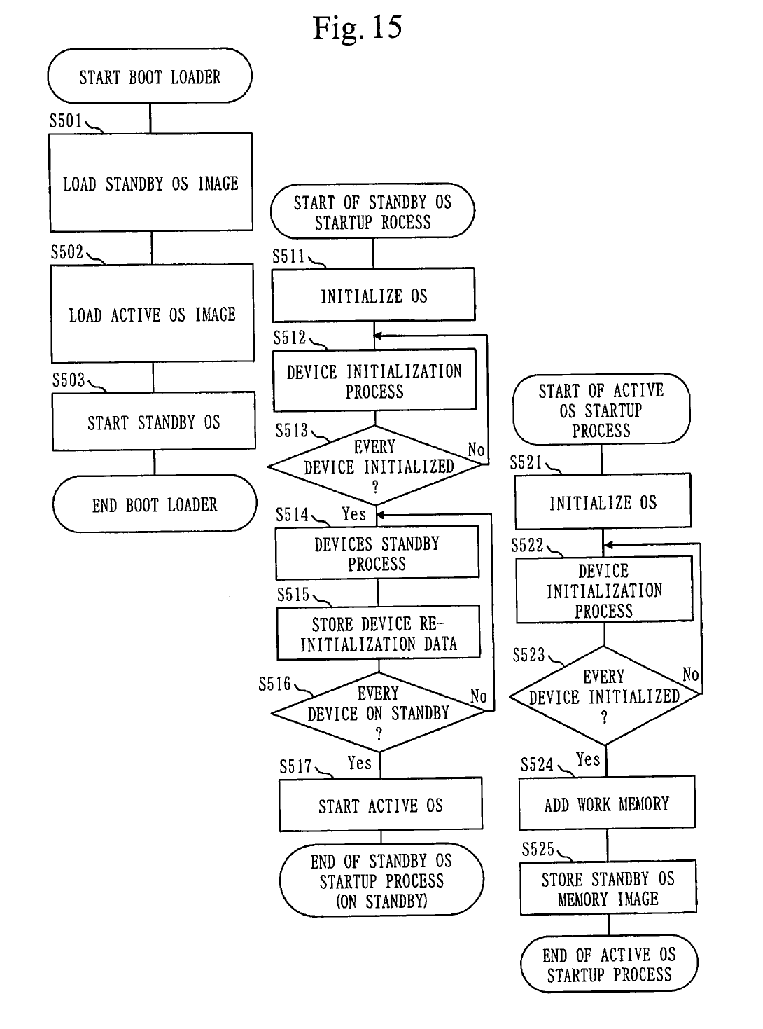

An operation of the information processing apparatus 100 according to the third embodiment of the present invention is described. FIG. 15 shows flow charts illustrating an operation at system startup of the information processing apparatus 100 of the third embodiment. However, the procedure illustrated in the flow charts is only an example. Alternatively, a different procedure may be used as long as an equivalent result can be achieved.

When the processor 101 starts executing the boot loader 201 after the information processing apparatus 100 of the third embodiment is started, standby OS image loading is performed in the same manner as that described in the first embodiment (S501), first. The rest of the operation is similar to that described in the first embodiment until the work memory adding process of the active OS 410c at S514.

After having performed the work memory adding process at S514, the processor 101 causes the standby OS memory image storing section 416 of the active OS 410c to store in the ROM 103 information stored in the standby OS memory 205 as the standby OS memory image 208 (S525). The startup process of the active OS 410c is completed when S525 is finished. Then, the processor 101 causes the normality processing section 414 of the active OS 410c to perform the OS process in the normal state after system startup.

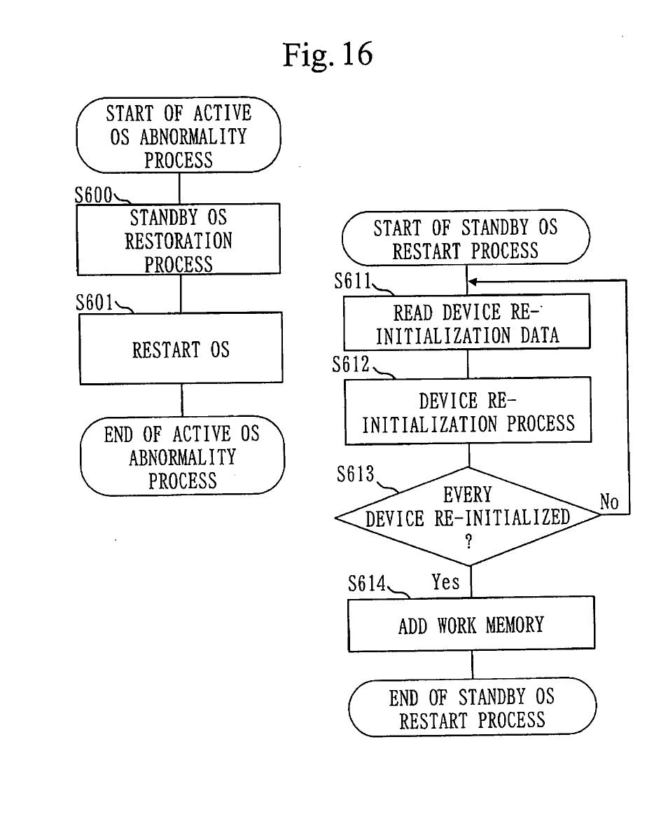

FIG. 16 shows flow charts illustrating an OS restart operation when an abnormality occurs during the execution of the active OS 410c of the information processing apparatus 100 of the third embodiment. When an abnormality occurs during the execution of the active OS 410c, the processor 101 executes the abnormality processing section 415c of the active OS 410c. Then, the processor 101 causes the standby OS restoring section 417 to read the standby OS memory image 208 stored in the ROM 103 and restore the standby OS 420c in the standby OS memory 205 in the RAM 102 (S600). This restored standby OS 420c is the standby OS which has been initialized during system startup, and which has stored the re-initialization data for the devices. Then, the processor 101 causes the restart processing section 425 of the standby OS 420c to start the restart process of the standby OS 420c in a similar manner to that of the first embodiment (S601). Here, the processing by the abnormality processing section 415b of the active OS 410c ends.

The standby OS restart processing of S611 to S614 after the processor 101 has started executing the restart processing section 425 is similar to that described in the first embodiment. After the restart process by the standby OS 420c has been completed, the standby OS 420c performs the OS process in the normal state after OS restart, in a similar manner to that described in the first embodiment.

After that, when an abnormality is detected while the standby OS 420c is performing the OS process in the normal state, the processor 101 executes the abnormality processing section 429 of the standby OS 420c. By executing the abnormality processing section 429, the processor 101 starts processing by the abnormality processing section 415c of the active OS 410c. As a result, the standby OS memory image is read from the ROM 103 again, the standby OS 420c is restored in the standby OS memory 205, and the standby OS 420c is restarted again.

As aforementioned, the standby OS stores the device re-initialization data according to the startup system configuration at each system startup of the information processing apparatus, and upon OS restart, re-initializes currently connected devices with reference to the stored device re-initialization data. This can contribute to a reduction in processing time required for setting the devices upon OS restart even when there is a system configuration change in the information processing apparatus due to a change in the connected devices.

Further, the memory image of the standby OS whose initial settings have been completed at startup of the information processing apparatus has been stored in the nonvolatile storage medium, and upon restart, the stored memory image of the standby OS at the startup is read from the nonvolatile storage medium, and the initialized standby OS at the system startup is restored in the memory medium. Therefore, there is no need for initializing the standby OS upon OS restart. This can contribute to a reduction in the startup time of the standby OS upon OS restart.

Further, the active OS and the standby OS share the same work memory. This can contribute to saving the work memory required for the system.

Further, OS restart is allowed not only when a failure occurs in the active OS but also when a failure occurs in the standby OS.

According to the information processing apparatus of the third embodiment, the standby OS memory image is stored in the nonvolatile storage medium for storing the boot loader and the like. The nonvolatile storage medium, however, is not the only destination for storage according to the present invention. Alternatively, the destination may be the memory medium for storing the active OS and the like, or may be a separately provided memory medium.

### REFERENCE SIGNS LIST

100: information processing apparatus, 101: processor, 102: RAM (memory medium), 103: ROM (nonvolatile storage medium), 104: first device, 105: second device, 201, 201b; boot loader, 202, 202c: active OS image, 203, 203c: standby OS image, 204: active OS memory, 205: standby OS memory. 206: work memory, 207: common OS image, 208: standby OS memory image, 301, 301b: OS loading section, 302, 302b: standby OS starting section, 303: standby OS flag setting section, 410, 410c: active OS, 411: OS initializing section, 412, 4121-4122: device initializing section, 413: work memory attaching section, 414: normality processing section, 415, 415c: abnormality processing section, 416: standby OS memory image storing section, 417: standby OS restoring section, 420, 420c: standby OS, 421: OS initializing section, 422, 4221-4222: device initializing section, 423, 4231-4232: re-initialization data table, 424: active OS starting section, 425: restart processing section, 426, 4261-4262: device re-initializing section, 427: work memory attaching section, 428: normality processing section, 429: abnormality processing section, 431: OS determining section, 432: standby OS flag

1. An information processing apparatus comprising:
a processor;
a memory medium, connected to the processor, that stores an operating system (OS) to be executed by the processor;
one or more devices, connected to the processor, which are re-initialized upon OS restart;
an active OS, executed by the processor at system startup, that performs an initialization process for the devices, and performs an OS process in a normal state after the system startup; and
a standby OS, executed by the processor at the system startup, that:
detects the devices connected to the processor, performs an initialization process for the detected devices, and goes to standby; and
when an abnormality occurs in the active OS, and a restart is needed, re-initializes the devices by using re-initialization data for the devices stored during the initialization process before going to the standby.

2. The information processing apparatus of claim 1, wherein the processor executes the initialization process for the devices by the active OS, after executing the initialization process for the devices by the standby OS.

3. The information processing apparatus of claim 1, further comprising a nonvolatile storage medium, connected to the processor, that stores an OS image, wherein the nonvolatile storage medium stores a common OS image which is common to both the active OS and the standby OS, the common OS image being loaded to the memory medium as the standby OS and as the active OS.

4. The information processing apparatus of claim 1,
wherein the processor:
stores, in one of storage media provided in the information processing apparatus, a memory image of the standby OS which has initialized the devices and stored the re-initialization data for the devices during the system startup;
reads the stored memory image upon restart of the standby OS, and restores the standby OS in the one of storage media; and
executes the restored standby OS to restart the standby OS.

5. A program causing a processor connected to one or more devices, which is provided in an information processing apparatus, to execute:
a process, at system startup, to load a standby OS (Operating System) and an active OS from a nonvolatile storage medium to a memory medium for storing an OS to be executed by the processor;
an initialization process, after the standby OS and the active OS have been loaded, to detect the devices connected to the information processing apparatus by using the standby OS, and initialize the devices;
a storing process to store, in the memory medium, initialization data for the devices generated during the initialization process, as re-initialization data;
a process, after the storing process, to put the standby OS on standby and execute the active OS; and
when the standby OS is restarted,
a process to re-initialize the devices by using the re-initialization data stored by the storing process before the standby.
